(19) United States
(12) Patent Application Publication
(10) Pub. No.: US 2007/0061494 A1
(43) Pub. Date: Mar. 15, 2007

(54) Semiconductor memory system, semiconductor memory chip, and method of masking write data in a semiconductor memory chip

(76) Inventors: Paul Wallner, Prien (DE); Andre Schaefer, Munchen (DE); Thomas Hein, Munchen (DE)

Correspondence Address: EDELL, SHAPIRO & FINNAN, LLC, 1901 RESEARCH BLVD., SUITE 400, ROCKVILLE, MD, 20850, US

(21) Appl. No.: 11/214,068

(22) Filed: Aug. 30, 2005

(51) Int. Cl. G06F 5/00

(52) U.S. Cl. 710/52

(57) ABSTRACT

In a semiconductor memory chips, a semiconductor memory system, and a method of masking write data, data, command, and address signal streams are serially transmitted in the form of signal frames in accordance with a predefined protocol. The semiconductor memory system and predefined protocol are adapted to transfer write data mask bits in a close relation to respectively associated write data units within one write data/command stream. An interface section between a reception interface and a memory core of the semiconductor memory chip includes a frame decoder and a intermediate data buffer.

### FIELD OF THE INVENTION

The present invention relates to a semiconductor memory system, a semiconductor memory chip, and a method of masking write data signals, and more particularly, to an arrangement wherein the memory system and the memory chip are adapted for serially transmitting and receiving data, command, and address signal streams in form of signal frames in accordance with a predefined protocol.

### BACKGROUND

In conventional semiconductor memory systems and chips, such as SDR, DDR1-3, DRAMs write data are transmitted in parallel together with their write mask information. The latter is transferred to the memory array. The data mask information masks one byte from being written.

In future semiconductor memory systems, for example, DRAM memory systems and memory chips, data will be transmitted at a very high frequency. Write and read data are transmitted frame-based in a serial manner. Before the data can be written to the memory core, the data will be stored in an intermediate data buffer.

Investigations and discussions of several possible methods to carry out write data masking in a semiconductor memory system and a semiconductor memory chip include serial transmission of data, command, and address signal streams in the form of signal frames. If, according to one possible solution, write data are transmitted in different frames from their data mask and initiated by a separated command and the write mask information is sent at a different point of time initiated by its own command, there arises the problem that two intermediate data buffers are needed; one for intermediately storing write data and one for intermediately storing the write data mask bits before transferring both to the memory core. Also, this solution needs separate control paths for the two intermediate data buffers, which complicates the design.

A semiconductor memory system, a semiconductor memory chip, and a method of masking write data in which a semiconductor memory chip needs one buffer for intermediately storing write data and associated mask bits and one control path in order to simplify the memory chip design and the control scheme within the memory chip is desirable.

### SUMMARY

In a first exemplary embodiment, a semiconductor memory system having a memory controller unit and at least one semiconductor memory chip includes transmission and reception interface sections for serially transmitting and receiving data, command, and address signal streams in the form of signal frames in accordance with a predefined protocol via respective data, command, and address signal lanes to/from the memory controller and/or to/from another same memory chip, respectively. The predefined protocol and the semiconductor memory system are adapted to transfer write data mask bits close to respectively associated write data units within one write data/command stream. The at least one semiconductor memory chip further includes a memory core, a frame decoder arranged as an interface between the memory core and the reception interface section for decoding frame signals received from the latter, and an intermediate data buffer arranged for intermediately storing write data decoded by and received from the frame decoder to be transferred in parallel to the memory core. The frame decoder decodes the write data mask bits and transfers the write data mask bits in parallel and in synchronism with associated write data intermediately stored in the intermediate data buffer to the memory core.

In a second exemplary embodiment, a semiconductor memory system having a memory controller unit and at least one semiconductor memory chip includes transmission and reception interface sections for serially transmitting and receiving data, command, and address signal streams in the form of signal frames in accordance with a predefined protocol via respective data, command, and address signal lanes to/from the memory controller and/or to/from another same memory chip, respectively. The predefined protocol and the semiconductor memory system transfer write data mask bits close to respectively associated write data units within one write data/command stream. The at least one semiconductor memory chip further includes a memory core, a frame decoder arranged as an interface between the memory core and the reception interface section for decoding frame signals received from the latter, and an intermediate data buffer having a write data storing section and a mask bits storing section for intermediately storing in combination write data and associated write data mask bits decoded by and received from the frame decoder. The intermediate data buffer transfers in synchronism and in parallel to the memory core the write data and the associated write data mask bits as intermediately stored together in the intermediate data buffer.

In the semiconductor memory system according to the first exemplary embodiment, the write data mask bits are, for example, included and transferred from the reception interface section to the frame decoder within a “write to core” command frame decoded by the frame decoder to instruct the intermediate data buffer to transfer the intermediately stored write data and to instruct the frame decoder to transfer the associated write data mask bits in parallel to the memory core.

In the semiconductor memory system in accordance with the second exemplary embodiment the write data mask bits are, for example, included and transferred from the reception interface section to the frame decoder within at least one write data frame. The frame decoder transfers to the intermediate data buffer and to intermediately store in the intermediate data buffer each bit of the write data mask bits in parallel and in association to a respective write data unit.

In another aspect of the invention, a semiconductor memory chip according to the first exemplary embodiment includes transmission and reception interface sections for serially transmitting and receiving data, command, and address signal streams in the form of signal frames in accordance with a predefined protocol via respective data, command, and address signal lanes to/from a memory controller and/or to/from another same memory chip, respectively. The predefined protocol and the semiconductor memory chip transfer write data mask bits close to respectively associated write data units within one write data/command stream. The semiconductor memory chip further includes a memory core, a frame decoder arranged as an interface between the memory core and the reception interface section for decoding frame signals received from the latter, and an intermediate data buffer arranged for intermediately storing write data decoded by and received from the frame decoder to be transferred in parallel to the memory core. The frame decoder decodes the write data mask bits and transfers the write data mask bits in parallel and in synchronism with associated write data intermediately stored in the intermediate data buffer to the memory core.

In yet another aspect of the invention, a semiconductor memory chip according to the second exemplary embodiment includes transmission and reception interface sections for serially transmitting and receiving data, command, and address signal streams in the form of signal frames in accordance with a predefined protocol via respective data, command, and address signal lanes to/from the memory controller and/or to/from another same memory chip, respectively. The predefined protocol and the semiconductor memory system transfer write data mask bits close to respectively associated write data units within one write data/command stream. The at least one semiconductor memory chip further includes a memory core, a frame decoder arranged as an interface between the memory core and the reception interface section for decoding frame signals received from the latter, and an intermediate data buffer having a write data storing section and a mask bits storing section for intermediately storing in combination write data and the associated write data mask bits decoded by and received from the frame decoder. The intermediate data buffer transfers in synchronism and in parallel to the memory core the write data and the associated write data mask bits as intermediately stored together in the intermediate data buffer.

In the semiconductor memory chip in accordance with the first exemplary embodiment, the write data mask bits are included and transferred from the reception interface section to the frame decoder within a “write to core” command frame decoded by the frame decoder to instruct the intermediate data buffer to transfer the intermediately stored write data and to instruct the frame decoder to transfer the associated write data mask bits in parallel to the memory core. In the semiconductor memory chip according to the second exemplary embodiment, the write data mask bits are included and transferred from the reception interface section to the frame decoder within at least one write data frame, and the frame decoder is adapted to transfer to and to intermediately store in the intermediate data buffer each bit of the write data mask bits in parallel and in association to a respective write data unit.

In the present semiconductor memory system and the semiconductor memory chip as described above, each write data mask bit is provided for masking one byte of write data, that is, one write data unit includes one byte.

A method of masking write data by write data mask bits includes serially transmitting in a close relation and in interrelated association both the write data mask bits and respectively associated write data units to be masked within one data/command stream in the form of signal frames in accordance with a predefined protocol to a semiconductor memory chip, decoding frames of write data units and associated write data mask bits by the frame decoder, transferring the decoded write data units and the associated write data mask bits in synchronism and in parallel to the memory core, and masking in the memory core a respective unit of write data by one associated write data mask bit transferred. The semiconductor memory chip includes a memory core, and a frame decoder.

In accordance with the first exemplary embodiment, the write data units as decoded by the frame decoder are intermediately stored before transferring both, the write data units and the associated write data mask bits by transferring the decoded write data units and associated write data mask bits in parallel to the memory core.

Alternatively, in a second exemplary embodiment, the masking method intermediately stores not only the write data units but also each decoded write data mask bit in association to the respectively decoded write data unit.

The decoding and transferring of the masking method of the present invention are both carried out synchronously to a common synchronizing clock signal.

The synchronizing clock signal is preferably the frame clock signal. Alternatively, the decoding and transferring of the masking method use a synchronizing clock signal that has a higher frequency than the frame clock signal, but is phase-aligned to the frame clock signal.

The semiconductor memory system, memory chip, and masking method combine write data units and associated data mask bits into one data stream so that the corresponding associated data mask is close to its data unit (data byte). In this way, the write data stream can be de-serialized and parallelized, and less control is needed. The intermediate data buffer can be a combined write data and write data mask buffer. For example, a frame protocol that incorporates write data and mask bits in a close relation so that both can be handled together leads to an easier implementation of the write data path.

Other and further features and aspects of the semiconductor memory system, memory chip, and masking method will appear more fully from the following description.

### BRIEF DESCRIPTION OF THE DRAWINGS

The accompanying drawings, which are incorporated in and constitute a part of the specification, illustrate exemplary embodiments of the semiconductor memory system, memory chip, and masking method, and together with the general description given above and the detailed description given below serve to explain the principles of the invention. Even if the present semiconductor memory system and the masking method are primarily destined to the use of DRAM memory chips, the principles of the present invention can likewise be applied to semiconductor memory systems and a masking method using other semiconductor memory chips than DRAM chips.

FIG. 1 schematically depicts a functional block diagram of a section within a semiconductor memory chip forming and including main components of a write data/command reception and decoding path.

FIGS. 2A-2E schematically depict a process of sequentially transferring and intermediately storing in an intermediate data buffer write data units (FIGS. 2A-2D) and a process of transferring the intermediately stored write data units in parallel with data mask bits as decoded from a “write to core” command frame to the memory core (FIG. 2E) in accordance with a first exemplary embodiment of the present semiconductor memory system, memory chip, and masking method.

FIGS. 3A-3E schematically depict transferring to and intermediately storing in an intermediate data buffer write data units together with associated write data mask bits and transferring both the write data units and the write data mask bits in parallel by a “write to core” command to the memory core in accordance with a second exemplary embodiment of the present semiconductor memory system, memory chip, and masking method.

### DETAILED DESCRIPTION

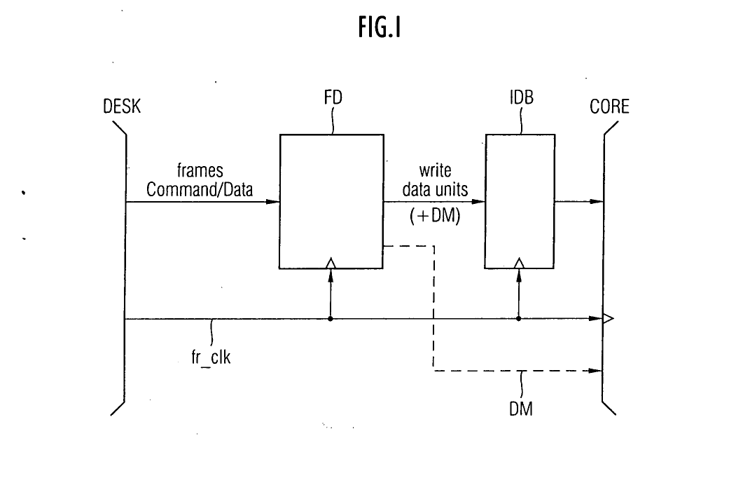

FIG. 1 schematically depicts a section of a write data/command reception and decoding section forming an interface between a memory core CORE and a reception interface section symbolized by a deskew DESK unit of a semiconductor memory chip which includes a transmission interface section (not shown) and the reception interface section DESK for serially transmitting and receiving data, command, and address signal streams in form of signal frames in accordance with a predefined protocol via respective data, command, and address signal lanes (not shown) to/from a memory controller (not shown) and/or to/from another same memory chip (not shown), respectively. The predefined protocol and the memory chip transfer write data mask bits close to respectively associated write data units within one write data/command stream.

Between the reception interface section DESK and the memory core CORE, the circuit section forming the write data/command reception and decoding section includes a frame decoder FD arranged for decoding frame signals received from the reception interface section DESK and an intermediate data buffer IDB arranged for intermediately storing write data units decoded by and received from the frame decoder FD. The write data units intermediately stored in the intermediate data buffer IDB are transferred in parallel to the memory core CORE.

According to a first exemplary embodiment of the present semiconductor memory chip, the frame decoder FD decodes the write data mask bit DM as transferred from the reception interface section DESK close to the associated write data units within one write data/command stream and transfers the write data mask bits DM in parallel and in synchronism with associated write data units intermediately stored in the intermediate data buffer IDB to the memory core CORE. That is, according to the present embodiment, the IDB intermediately stores the write data units decoded and sequentially transferred from the frame decoder FD. The frame decoder FD receives the write data mask bits DM within the command frame “write to core” enables the IDB to transfer the intermediately stored write data units. The FD transfers the write data mask bits DM in parallel and in synchronism with the transfer of the write data units from the IDB to the CORE. In FIG. 1, the path for transferring the write data mask bits from FD to the CORE in accordance to the first exemplary embodiments is designated “DM” and drawn by a broken line. Operation of FD, IDB, and the transfer of each of the write data units and the write data mask bits DM are synchronized by a synchronizing clock signal, for example, the frame clock signal fr_clk, but may also be a synchronizing clock signal having a higher frequency than the frame clock signal, but phase aligned to the frame clock signal.

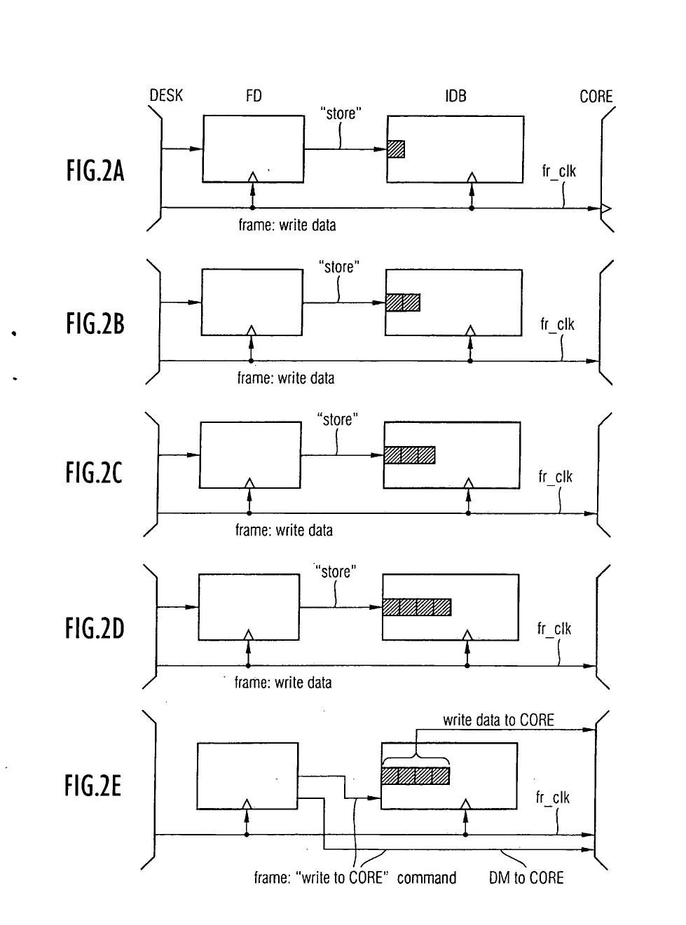

FIGS. 2A-2E schematically depict a sequential transfer of four write data units included in a first to fourth data frame from FD to the IDB (process steps 1 to 4, FIGS. 2A-2D) and the transfer of the intermediately stored four write data units from the IDB to CORE (FIG. 2E) and a parallel and synchronized transfer of the associated write data mask bits from FD to CORE in accordance with the first exemplary embodiment of the present semiconductor memory chip and of the present masking method. These actions are synchronized by the synchronizing frame clock signal fr_clk.

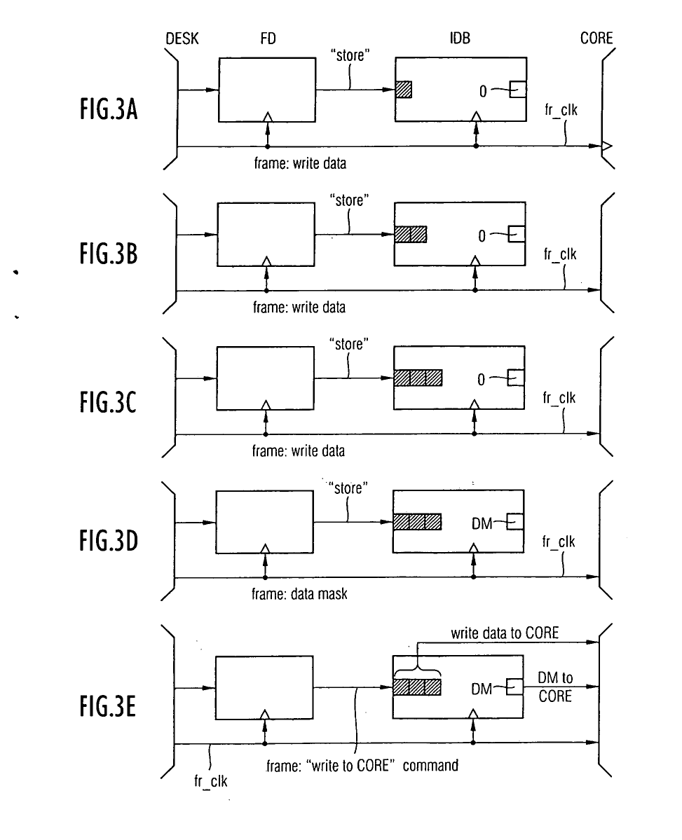

Alternatively, FIGS. 3A-3E schematically depict intermediate storage of a first to third write data unit and a data mask bit decoded and transferred from the frame decoder FD within the intermediate data buffer IDB (process steps 1-4, FIGS. 3A-3D) and the parallel transfer of the intermediately stored write data units and the intermediately stored data mask bit DM from IDB to CORE in synchronism with the synchronizing frame clock signal fr_clk (FIG. 3E). That is, IDB includes a write data storage section for storing write data units and a mask bit storing section for storing data mask bits DM.

Like the process step depicted in FIG. 2E, the process step shown in FIG. 3E is enabled or initiated by a command “write to core” decoded by the frame decoder FD.

A prerequisite of the first and second exemplary embodiments described above and the corresponding first and second exemplary embodiments of the masking method is that the predefined protocol on which the serial transmission and reception of data, command, and address signal streams in the form of signal frames is based and a semiconductor memory system using the present first and second exemplary embodiments of the semiconductor memory chip transfer write data mask bits close to respectively associated write data units within one write data/command stream.

A semiconductor memory system according to the present invention can include at least one semiconductor memory chip and the memory controller unit.

A method of masking write data by write data mask bits according to the present invention includes serially transmitting in a close relation and interrelated association both the write data mask bits and respectively associated write data units to be masked within one data/command stream in the form of signal frames in accordance with a predefined protocol to a semiconductor memory chip, decoding frames of write data units and associated write data mask bits by the frame decoder, transferring the decoded write data units and the associated write data mask bits in synchronism and in parallel to the memory core, and masking in the memory core a respective unit of write data by one associated write data mask bit as transferred. The semiconductor memory chip at least includes a memory core and a frame decoder.

While the invention has been described in detail and with reference to specific embodiments thereof, it will be apparent to one skilled in the art that various changes and modifications can be made therein without departing from the spirit and scope thereof. For example, some or all of the subject matter may be embodied as software, hardware or a combination thereof. Accordingly, it is intended that the present invention covers the modifications and variations of this invention provided they come within the scope of the appended claims and their equivalents.

What is claimed:

1. A semiconductor memory system, comprising:
a memory controller unit; and
at least one semiconductor memory chip, the at least one semiconductor memory chip including transmission and reception interface sections for serially transmitting and receiving data, command, and address signal streams in the form of signal frames in accordance with a predefined protocol via respective data, command, and address signal lanes to/from the memory controller unit and/or to/from another same memory chip, respectively, the predefined protocol and the semiconductor memory system transferring write data mask bits close to respectively associated write data units within one write data/command stream, the at least one semiconductor memory chip further including a memory core, a frame decoder arranged as an interface between the memory core and the reception interface section for decoding frame signals received from the reception interface section, and an intermediate data buffer arranged for intermediately storing write data decoded by and received from the frame decoder to be transferred in parallel to the memory core, the frame decoder decoding the write data mask bits and transferring the write data mask bits in parallel and in synchronism with associated write data intermediately stored in the intermediate data buffer to the memory core.

2. A semiconductor memory system, comprising:
a memory controller unit; and
at least one semiconductor memory chip, the at least one semiconductor memory chip including transmission and reception interface sections for serially transmitting and receiving data, command, and address signal streams in the form of signal frames in accordance with a predefined protocol via respective data, command and address signal lanes to/from the memory controller unit and/or to/from another same memory chip, respectively, the predefined protocol and the semiconductor memory system transferring write data mask bits close to respectively associated write data units within one write data/command stream, the at least one semiconductor memory chip further including a memory core, a frame decoder arranged as an interface between the memory core and the reception interface section for decoding frame signals received from the reception interface section, and an intermediate data buffer having a write data storing section and a mask bits storing section for intermediately storing in combination write data and associated write data mask bits decoded by and received from the frame decoder, the intermediate data buffer transferring in synchronism and in parallel to the memory core the write data and the associated write data mask bits as intermediately stored together in the intermediate data buffer.

3. The semiconductor memory system as claimed in claim 1, wherein each write data mask bit masks one byte of write data.

4. The semiconductor memory system as claimed in claim 1, wherein the write data mask bits are included and transferred from the reception interface section to the frame decoder within a “write to core” command frame decoded by the frame decoder to instruct intermediate data buffer to transfer the intermediately stored write data and to instruct the frame decoder to transfer the associated write data mask bits in parallel to the memory core.

5. The semiconductor memory system as claimed in claim 2, wherein the write data mask bits are included and transferred from the reception interface section to the frame decoder within at least one write data frame, and the frame decoder transfers to and intermediately stores in the intermediate data buffer each bit of the write data mask bits in parallel and in association to a respective write data unit.

6. A semiconductor memory chip, comprising:
transmission and reception interface sections for serially transmitting and receiving data, command, and address signal streams in the form of signal frames in accordance with a predefined protocol via respective data, command, and address signal lanes to/from a memory controller and/or to/from another same memory chip, respectively, the predefined protocol and the semiconductor memory chip transferring write data mask bits close to respectively associated write data units within one write data/command stream, the semiconductor memory chip further including a memory core, a frame decoder arranged as an interface between the memory core and the reception interface section for decoding frame signals received from the reception interface section, and an intermediate data buffer arranged for intermediately storing write data decoded by and received from the frame decoder to be transferred in parallel to the memory core, the frame decoder decoding the write data mask bits and transferring the write data mask bits in parallel and in synchronism with associated write data intermediately stored in the intermediate data buffer to the memory core.

7. A semiconductor memory chip, comprising:
transmission and reception interface sections for serially transmitting and receiving data, command, and address signal streams in form of signal frames in accordance with a predefined protocol via respective data, command and address signal lanes to/from a memory controller and/or to/from another same memory chip, respectively, the predefined protocol and the semiconductor memory chip transferring write data mask bits close to respectively associated write data units within one write data/command stream, the semiconductor memory chip further including a memory core, a frame decoder arranged as an interface between the memory core and the reception interface section for decoding frame signals received from the reception interface section, and an intermediate data buffer having a write data storing section and a mask bits storing section for intermediately storing in combination write data and the associated write data mask bits decoded by and received from the frame decoder, the intermediate data buffer transferring in synchronism and in parallel to the memory core the write data and the associated write data mask bits as intermediately stored together in the intermediate data buffer.

8. The semiconductor memory chip as claimed in claim 6, wherein each write data mask bit masks one byte of write data.

9. The semiconductor memory chip as claimed in claim 6, wherein the write data mask bits are included and transferred from the reception interface section to the frame decoder within a “write to core” command frame decoded by the frame decoder to instruct the intermediate data buffer to transfer the intermediately stored write data and to instruct the frame decoder to transfer the associated write data mask bits in parallel to the memory core.

10. The semiconductor memory chip as claimed in claim 7, wherein the write data mask bits are included and transferred from the reception interface section to the frame decoder within at least one write data frame, the frame decoder transfers to and intermediately stores in the intermediate data buffer each bit of the write data mask bits in parallel and in association to a respective write data unit.

11. A method of masking write data by write data mask bits, the method comprising:
serially transmitting in a close relation and interrelated association both the write data mask bits and respectively associated write data units to be masked within one data/command stream in the form of signal frames in accordance with a predefined protocol to a semiconductor memory chip, the semiconductor memory chip including a memory core, and a frame decoder;
decoding frames of write data units and associated write data mask bits by the frame decoder;
transferring the decoded write data units and the associated write data mask bits in synchronism and in parallel to the memory core; and
masking in the memory core a respective unit of write data by one associated write data mask bit as transferred.

12. The method as claimed in claim 11, wherein the decoding frames of write data units and associated write data mask bits by the frame decoder includes intermediately storing a plurality of write data units decoded by the frame decoder before transferring the write data units in parallel to the memory core.

13. The method as claimed in claim 12, wherein the intermediate storing intermediately stores each decoded write data mask bit in association to the respectively decoded write data unit.

14. The method as claimed in claim 11, wherein the write data unit includes one byte of write data.

15. The method as claimed in claim 11, wherein the decoding and transferring are respectively carried out synchronously to a common synchronizing clock signal.

16. The method as claimed in claim 11, wherein the decoding and transferring are respectively carried out in synchronism to a frame clock signal.

17. The semiconductor memory system as claimed in claim 2, wherein each write data mask bit masks one byte of write data.

18. The semiconductor memory chip as claimed in claim 7, wherein each write data mask bit masks one byte of write data.
